(19) United States
(12) Patent Application Publication
(10) Pub. No.: US 2026/0333533 A1
(43) Pub. Date: Oct. 22, 2026

(54) LIGHT EMITTING DIODE (LED) ARRAY CALIBRATION USING LOOK UP TABLES (LUTS)

(71) Applicant: Microchip Technology Incorporated, Chandler, AZ (US)

(72) Inventors: Martin Miller, Karlsruhe (DE); Thorsten Konrad Kummermehr, Ubstadt-Weiher (DE)

(73) Assignee: Microchip Technology Incorporated, Chandler, AZ (US)

(21) Appl. No.: 19/250,471

(22) Filed: Jun. 26, 2025

Related U.S. Application Data
(60) Provisional application No. 63/790,654, filed on Apr. 17, 2025.

(51) Int. Cl. H05B 45/14; H05B 45/18

(52) U.S. Cl. CPC H05B 45/14; H05B 45/18

(57) ABSTRACT

An apparatus, such as a Controller Area Network (CAN)-based node, may include memory storing a plurality of lookup tables. The apparatus may also include processing circuitry to calculate calibrated brightness values for light emitting diodes (LEDs), where each calibrated brightness value is based on a value indicating a desired brightness, a temperature value, and an age value. The calibrated brightness values may be stored in the lookup tables and output brightness signals for LEDs of an array may be determined using the stored lookup tables.

### CROSS-REFERENCE TO RELATED APPLICATIONS

This application claims the benefit of U.S. Provisional Patent Application No. 63/790,654, filed Apr. 17, 2025.

### TECHNICAL FIELD

The present disclosure relates generally to calibrating light emitting diodes (LEDs), and more particularly, to LED array calibration using lookup tables (LUTs).

### BACKGROUND

Each LED of an array has a unique, specific curve of its light emission based on a given pulse width modulation (PWM) driver signal. Thus, an array of LEDs can have visible effects if the differences in emission for each LED are not taken into account, and calibration is required. The calibration of multiple LEDs requires a complex mathematical function that is dependent on an LED's calibration curve, age, or the temperature. In large LED arrays, calibration using these complex mathematical functions requires a powerful microcontroller, increasing costs or complexity of the LED control system.

### SUMMARY OF THE INVENTION

Aspects herein provide lookup tables storing calculated calibrated brightness values for light emitting diodes (LEDs) and using the lookup tables to provide output brightness signals to drive LEDs. The calibrated brightness values may be re-calculated periodically, e.g., as opposed to at each LED refresh, allowing for reduced calculation times, reduced processing power needed for LED array systems, or both.

In one aspect, an apparatus includes: memory storing a plurality of lookup tables; and circuitry to: calculate calibrated brightness values for light emitting diodes (LEDs), each calibrated brightness value based on a value indicating a desired brightness, a temperature value, and an age value; store the calibrated brightness values in the lookup tables; receive input brightness signals for a plurality of LEDs; and determine, based on the lookup tables, output brightness signals corresponding to the input brightness signals.

In another aspect, a method includes: calculating a plurality of calibrated brightness values for a light emitting diode (LED), each calibrated brightness value based on a desired brightness of the LED, a temperature of the LED, and an age of the LED; storing the calibrated brightness values in lookup tables; receiving input signals indicating a desired brightness for a plurality of LEDs; and determining, using the lookup tables, output signals for the plurality of LEDs based on the input signals.

In yet another aspect, one or more machine-readable storage media have instructions stored thereon, wherein the instructions, when executed by processing circuitry, cause the processing circuitry to: calculate a plurality of calibrated brightness values, each calibrated brightness value based on a desired brightness value, a temperature value, and an age value; store the calibrated brightness values in lookup tables; and determine, using the lookup tables, output signals for a plurality of LEDs based on input signals indicating desired brightness values for the plurality of LEDs.

In still another aspect, a device includes: an array of light emitting diodes (LEDs); driver circuitry for the LEDs; memory storing a plurality of lookup tables, each lookup table including a plurality of calibrated brightness values for an LED corresponding to respective input brightness values for the LED; an input interface; and processing circuitry to: calculate the calibrated brightness values, each calibrated brightness value calculated based on an input brightness value, a temperature value, and an age value; store the calibrated brightness values in the lookup tables; receive, from the input interface, input brightness signals for the LEDs; determine, based on the lookup tables, output brightness signals for the LEDs based on the input brightness signals.

### BRIEF DESCRIPTION OF THE DRAWINGS

FIG. 1 illustrates an example system that includes a microcontroller unit (ASIC), a pulse width modulation (PWM) driver circuit, and an LED array.

FIG. 2 illustrates an example lookup table (LUT) of the present disclosure.

FIG. 3 illustrates an example process of using LUTs to provide calibrated brightness values for driving an LED array.

FIG. 4 illustrates a simplified diagram of an example vehicle that includes a Controller Area Network (CAN)-based bus with multiple nodes.

FIG. 5 illustrates an example CAN-based node that may implement aspects of the present disclosure.

### DETAILED DESCRIPTION

The present disclosure relates to the control of LED arrays using lookup tables (LUTs). Currently, the calibration of multiple LEDs in an array requires a complex mathematical function that is dependent on each LED's calibration curve, age, or the temperature. The calibration is typically calculated for each LED at each change or refresh, requiring a relatively large amount of processing power in the microcontroller unit (ASIC). This can lead to increased costs or complexity for systems that include large LED arrays.

Aspects of the present disclosure, on the other hand, may implement software algorithms for LED array calibration that utilize LUTs, reducing calculation times or the processing power needed for LED array ASICs. The LUTs may be pre-determined and may take into account LED age for temperature. LEDs of an array may be assigned to one of multiple stored LUTs, e.g., based on its specific calibration curve, age, or temperature. The LUTs may then be used to determine output signals for driving corresponding LEDs of the array, and the performance of complex mathematical functions for each LED at each change is avoided.

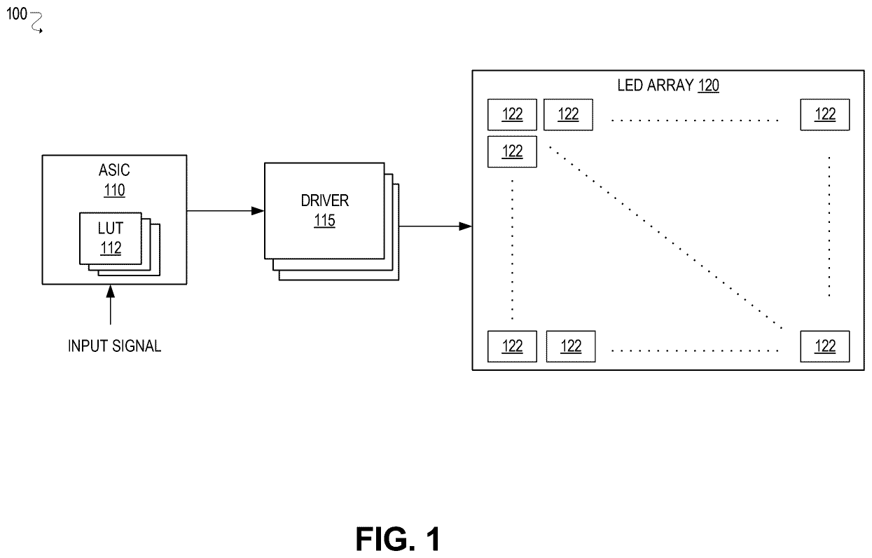

FIG. 1 illustrates an example system 100 that includes an application specific integrated circuit (ASIC) 110, a driver circuit 115, and an LED array 120. The system 100 may include additional (or fewer) components than shown, or may include the components shown in different locations (e.g., the LUTs 112 may be stored outside of the ASIC 110 or the driver circuit 115 may be collocated with (e.g., incorporated in an apparatus comprising) the ASIC 110 or the LED array 120). Further, although shown as utilizing an ASIC 110, the system 100 may utilize a microcontroller (MCU) or other type of processing circuitry in other examples.

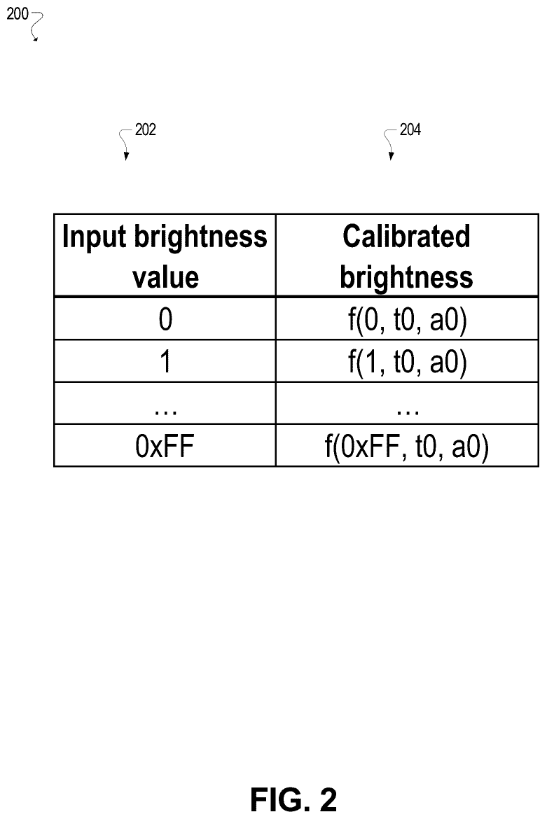

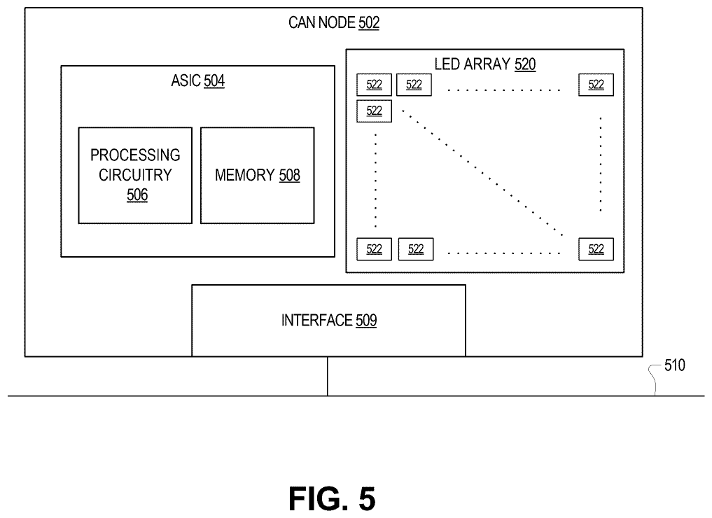

The ASIC 110 may include memory and processing circuitry, e.g., similar to the processing circuitry 506 and memory 508 of the ASIC 504 shown in FIG. 5. The ASIC 110 stores a plurality of LUTs 112, which each include calibrated brightness values for the LEDs of the LED array 120. The calibrated brightness values may be values to be output to the LED array based on received desired brightness values, as described further below with respect to FIG. 2. The ASIC 110 may perform initial calculations of the calibrated brightness values, which may be based on based on a calibration curve for the LED, age values for the LED, or temperature values for the LED as described below. The ASIC 110 may then re-calculate the calibrated brightness values to be stored in the LUTs 112 at certain times, e.g., after a predetermined amount of time (e.g., after 10, 15, 20, or 30 seconds), or after a particular change in temperature of the LEDs of the array 120 (e.g., a change in temperature of +/−2 °C, +/−5 °C, or +/−10 °C), which may depend on the range of temperatures used to calculate the calibrated brightness values as described below.

The ASIC 110 may calculate and store in a LUT 112 a set of calibrated brightness values that correspond to a desired brightness value, a particular age value, and a particular temperature value. That is, each LUT 112 may correspond to a particular age value and a particular temperature value, and may include a set of input brightness values and corresponding output calibrated brightness values, as shown in FIG. 2. The ASIC 110 may calculate the calibrated brightness values for a particular range of temperature values, where the range of temperature values is based on a current temperature of the LEDs of the array 120. In some implementations, the ASIC 110 may perform the calculations using the same age value for each LUT, since the relative age of the LEDs might not change much between re-calculations. For example, the ASIC 110 may calculate calibrated brightness values using a particular age value (which may be a value stored by the LED array 120 or by another component of the system 100), over a range of temperature values that is +/−5 °C or +/−10 °C of a current LED temperature at suitable steps (e.g., at steps of 1 °C). For example, there may be 11 LUTs 112: one LUT corresponding to a temperature of the LEDs at the time of calculation by the ASIC, five LUTs for each of the ten degrees below that temperature, and five LUTs for each of the ten degrees above that temperature.

In some implementations, the LED array may include a red, a green, and a blue LED in each pixel 122. Thus, calibrated brightness values may be calculated for each type of LED, using a separate calibration function for each type. The LUTs 112 may accordingly include a first set of LUTs may store calibrated brightness values calculated using the calibration function for the red LEDs, a second set of LUTs may store calibrated brightness values calculated using the calibration function for the green LEDs, and a third set of LUTs may store calibrated brightness values calculated using the calibration function for the blue LEDs.

The ASIC 110 may then associate each LED of the array 120 with one of the LUTs 112 and utilize the relevant LUTs 112 to determine the output brightness signal to provide to the driver circuitry 115. The association of each LED with a particular LUT 112 may be based on a current temperature of the LED(s) and may occur at any suitable time. In some implementations, the association may be performed at each calculation of the calibrated brightness values by the ASIC 110, and may be done any number times between calculations of the calibrated brightness values.

The LED array 120 may include any suitable number of pixels 122, which may be arranged in a grid as shown in FIG. 1 or in another manner (e.g., in a linear arrangement). In some examples, each pixel 122 includes a single LED, while in other examples, each pixel 122 includes multiple LEDs. For example, each pixel 122 may include one red LED, one green LED, and one blue LED. The system 100 further includes driver circuitry 115 to drive the LEDs of the LED array 120. In some examples, the driver circuitry 115 may include a single driver circuit, while in other examples, the driver circuitry 115 may include multiple driver circuits. For example, in some implementations, the driver circuitry 115 may include a driver circuit for the red LEDs of the array, a driver circuit for the green LEDs of the array, and a driver circuit for the blue LEDs of the array. In some implementations, the driver circuitry 115 may include a driver circuit for each individual pixel 122.

In operation, the ASIC 110 may receive input signals that include information to be displayed on or by the LED array 120. The ASIC 110 may receive the signal over any suitable interface (e.g., the interface 509 of the ASIC 504 shown in FIG. 5), which, in some examples, may be a Controller Area Network (CAN)-based interface, an Ethernet interface, or other type of interface. The input signal may include, for example, text or video information that is to be displayed by the LED array 120. The input signal may include desired brightness values for each of the LEDs of the array 120, e.g., desired brightness values for each of the red, green, and blue LEDs of each pixel 122 of the array 120. The desired brightness values may be in any suitable format, such as, for example, 8 bit, 12 bit, or 16 bit values.

The ASIC 110 then determines, using the LUTs 112, brightness signals to output to the driver circuitry 115 based on the desired brightness values received. As previously described, each LED of the array 120 may be associated with one of the LUTs 112 by the ASIC 110, and the ASIC 110 may utilize the associated LUT of an LED to determine the calibrated brightness value to output for that particular LED. That is, instead of performing these calculations at each LED refresh, as is typically done, the ASIC may utilize the pre-calculated values stored in the LUTs 112, reducing overall utilization of processing resources or power consumption of the ASIC. The driver circuitry 115 may then generate PWM signals to be provided to the LEDs to illuminate the LEDs.

In some implementations, one or more of the components of the system 100 may be included in a CAN node, such as the CAN node 502 shown in FIG. 5. For example, in some implementations, a CAN node may include the ASIC 110 without the driver circuitry 115 and LED array 120. However, in other implementations, a CAN node may include the ASIC 110, the driver circuitry 115, and the LED array 120. The CAN node can also include additional or other components than those shown.

FIG. 2 illustrates an example lookup table (LUT) 200 according to the present disclosure. The example LUT 200 includes calibrated brightness values 204 that are to be output based on corresponding input brightness values 202. In the example shown, the input brightness values 202 are 16 bit values that range from 0 to 0xFF, and the calibrated brightness values 204 may be similarly formatted at 16 bit values. However, the LUTs of the present disclosure may be formatted differently. For example, the input brightness values 202 and calibrated brightness values 204 may be 8 bit or 12 bit values. As another example, the calibrated brightness values 204 may be formatted as PWM parameters (e.g., duty cycle and frequency) that can be used to drive LEDs.

The calibrated brightness values 204 may be calculated based on a calibration function, which may be represented by:

f(b,t,a)=ϵ([0x0000; 0xFFFF])

where b represents an input or desired brightness value for an LED, t represents a temperature of the LED, and a represents an age of the LED. In this example, the output is a 16 bit number. The calibration function may be based on a particular type of LED; for example, values for red LEDs of an array may be based on a first calibration function that is different from a second calibration function used to calculate values for green LEDs of the array, which is still different from a third calibration function used to calculate values for blue LEDs of the array. Typically, these calculations may be performed at each refresh of an LED, for each LED of an array. For instance, in an array of LEDs (e.g., array 120) with a resolution r=width (w)×height (h), receiving new brightness values with a frequency (freq), the number (N) of calculations of f(b,t,a) performed may be represented as:

N=W*h*freq

Thus, for an LED array with a resolution of 640×320, updated with a frequency of 60 Hz, the number of calculations to be performed by an ASIC such as ASIC 110 may be N=640×320×60=12,288,000 calculations per second. This may be tripled where the calculations are to be performed for each of red LEDs, green LEDs, and blue LEDs of an array. The calibration function f(b,t,a) is typically a complex function requiring several divisions and multiplications, so performing these calculations in real time may call for an enormous calculation effort, especially for higher resolutions.

However, in aspects of the present disclosure, these calculations may be performed initially and then at various points thereafter, with the values being stored in LUTs as previously described. The updates of the calibrated brightness values stored in the LUTs may be performed relatively rarely, as the temperature and age of the LEDs in an array will not change quickly in many cases. That is, since temperature and age of an LED are values that do not change suddenly, these values may have no visible effect over a relatively short period of time (e.g., multiple seconds, minutes or even hours). Similarly, the change of the temperature of an LED may have no visible effect over a short period (e.g., multiple seconds) as well. Thus, f(b,t₀,a₀) may be considered to be approximately equal (or equal) f(b,t₁,a₁) for a time t₀ that is close to time t₁.

Accordingly, certain examples may calculate a LUT similar to LUT 200 that includes values 204 for a particular age that can be used to lookup output brightness values for a temperature t and a given desired brightness b input to the ASIC. In some cases, each LUT 112 may include values (e.g., 204) for a particular age and a particular temperature, as the LEDs of an array may vary in temperature. In some examples, a particular range of temperatures may be used to calculate output values, which may help to reduce the required memory for storage of the LUTs. Thus, whenever a PWM value for an LED needs to be looked up, a closest LUT may be used.

The rate of re-calculating the values 204 in the LUTs may vary, e.g., depending on the capabilities of the ASIC calculating the calibrated brightness values to store in the LUTs. For example, a less powerful ASIC may update a small portion of the LUTs in the synchronization gap between two frames. Even if the LUTs are updated after hundreds of frames, this may be a small amount of time, e.g., a few seconds. In any scenario, the ASIC may recalculate the values 204 infrequently, reflecting the slow changes in the temperature and age of the LEDs.

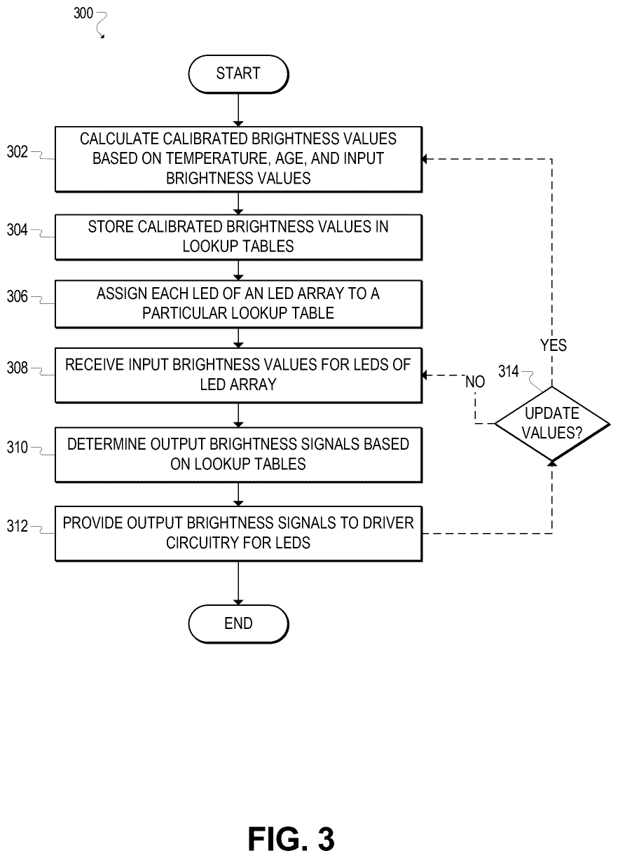

FIG. 3 illustrates an example process 300 of using LUTs to provide calibrated brightness values for driving an LED array. The process 300 may include additional, fewer, or other operations than those shown. In addition, operations in the process 300 may be performed in a different order than shown. In some cases, some of the operations shown may be performed simultaneously, in whole or in part. Further, some of the operations of the process 300 may include sub-operations, which may be performed serially or simultaneously, or in another manner. In some examples, the process 300 may be implemented by software, firmware, or hardware of an ASIC, such as the ASIC 110 of FIG. 1, or any combination thereof.

The flowchart begins at 302, where calibrated brightness values (e.g., the calibrated brightness values 204 shown in FIG. 2) are calculated. The calibrated brightness values may be calculated based on temperature values, age values, and input brightness values, as described above, and may be performed using the mathematical operations described above. The calibrated brightness values may be in a 8 bit, 12 bit, 16 bit, or another format. In some examples, the calibrated brightness values may be calculated using a calibration function for a particular type of LED, e.g., a first function for red LEDs of an array, a second, different function for green LEDs of an array, and a third, still different function for blue LEDs of an array.

At 304, the calibrated brightness values are stored in the LUTs (e.g., LUTs 112). The LUTs may be formatted in the same or similar manner as shown in FIG. 2 and described above. In some implementations, each LUT includes calibrated brightness values for a particular age aₓ and a particular temperature tₓ. In some implementations, the LUTs may store calibrated brightness values for a particular type of LED (e.g., red vs. green vs. blue LEDs). The LUTs may be stored in the memory of an ASIC (e.g., ASIC 110) or in another memory.

At 306, each LED of an LED array (e.g., LED array 120) is associated with a LUT of the stored LUTs (e.g., LUTs 112). For instance, in some implementations, each LED may be associated with a LUT of the stored LUTs based on its respective temperature, e.g., where the age of the LEDs of the array is the same. In some implementations, the association may be further based on respective ages of the LEDs, e.g., where age varies across the array of LEDs. The associations of LEDs to LUTs may be performed at any suitable time. In some implementations, the associations may be performed after each calculation at 302, and also at particular time intervals thereafter (e.g., any number of times between the calculations performed at 302). In some implementations, the associations may be performed in the event of a detected change in temperature (e.g., where LEDs are detected to have changed temperature more than a certain threshold number of degrees). In some cases, the association may be based on rounding temperature or age values. For example, where a temperature of an LED is 20.1 °C and there are LUTs corresponding to 20 °C and 21 °C, the LED may be associated with the former LUT rather than the latter.

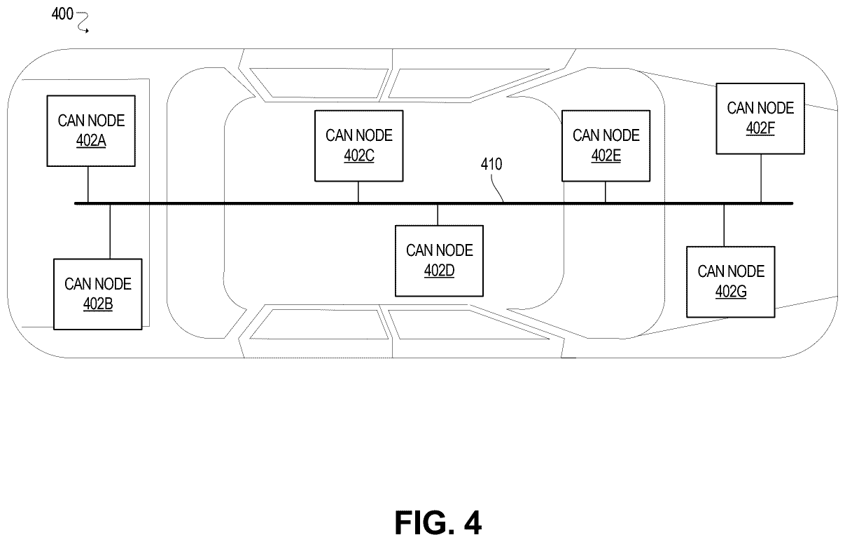

At 308, input brightness values are received for the LEDs of the LED array. The input brightness values may be received at, for example, an ASIC (e.g., 110) from an input interface that is compatible with a CAN-based bus (e.g., the CAN-based bus 410 of FIG. 4). The signals may be received from a node on the CAN-based bus (e.g., in another CAN node of the bus). In other implementations, the signals may be received from a graphics engine or other type of graphics processing unit. The input brightness values may be in any suitable format, such as, for example, an 8 bit, 12 bit, or 16 bit value.

At 310, the LUTs are used to obtain, for each LED, output brightness signals based on the input brightness values for the LED received at 308. For example, processing circuitry may perform a lookup in the LUT associated with a particular LED to determine a calibrated output brightness value that corresponds in the LUT with the input brightness value received for that particular LED.

At 312, an output signal is then generated for each LED based on the output brightness signal obtained from the LUT at 310. The output signal may be generated by driver circuitry for an LED array, e.g., the driver circuitry 115 of FIG. 1, and may be a PWM signal to drive the LED.

The process 300 may end at this point. However, in some examples, the process 300 may proceed to 314 where it is determined whether to update (e.g., re-calculate) the calibrated brightness values in the LUTs. For instance, in some cases, the process may return to 302 to re-calculate the calibrated brightness values stored in the LUTs if a particular amount of time has passed since the initial calculation performed at 302 or if a temperature of the LEDs has changed more than a certain amount since the previous calculation at 302. In other cases, the process 302 may return to 308 if the calibrated brightness values of the LUTs are not to be re-calculated at that particular moment.

Aspects of the present disclosure may be implemented in various environments that include LED arrays. For example, the techniques described herein may be implemented in interior or exterior automotive lighting systems, which may be implemented as nodes of a CAN-based bus. As another example, the techniques described herein may be implemented in industrial lighting systems, building automation systems, or the like.

FIG. 4 illustrates a simplified diagram of an example vehicle 400 that includes a Controller Area Network (CAN)-based bus 410 with multiple nodes 402A-G. As shown, the CAN-based bus 410 runs through the vehicle 400, interconnecting the nodes 402 with one another. The CAN-based bus 410 may implement a CAN protocol, such as CAN 2.0, CAN FD, or CAN XL. In other examples, however, the bus 410 may be implemented with a non-CAN-based protocol, such as Ethernet. For instance, in some examples, the bus 410 may be an Ethernet-based bus with CAN-based nodes 402 that implement an Ethernet-to-CAN translation circuit.

Any one of the nodes 402A-G of the vehicle 400 may implement one or more aspects of the present disclosure. For instance, one of the nodes 402 can include an ASIC similar to the ASIC 110 described above with respect to FIG. 1. The node 402, for example, may be able to receive input signals from the bus 410 that are to be displayed on an LED array (e.g., a gauge cluster or other type of display within or on the vehicle 400). The LED array may be integrated with the node 402 that includes the ASIC (along with the driver circuitry for the array), or may be implemented in a separate node 402 of the vehicle 400. The ASIC of the node 402 may use lookup tables (e.g., stored therein) to provide calibrated output brightness signals to the LED array as described above.

FIG. 5 illustrates an example CAN-based node 502 that may implement aspects of the present disclosure. The CAN-based node 502 may be connected to a CAN-based bus 510 in a similar manner as the nodes 402 connected to the bus 410 in FIG. 4, and the CAN-based bus 510 may be implemented in the same or similar manner as the bus 410 if FIG. 4. The CAN-based node 502 includes an ASIC 504 that includes processing circuitry 506 and memory 508. The ASIC 504 may include other components than those shown. The processing circuitry 506 may be configured to implement aspects of the present disclosure, e.g., to perform the operations shown in FIG. 3 and described above, and the memory 508 may be configured to store LUTs as described herein (e.g., LUTs similar to the LUTs 112 or the LUT 200). The CAN-based node 502 further includes an LED array 520 with a number of pixels 522. The LED array 520 may be implemented in the same or similar manner as the LED array 120 of FIG. 1. In other implementations, however, the CAN-based node 502 might not include the LED array 520, and the array 520 may be incorporated into another CAN-based node connected to the bus 510. The CAN-based node 502 further includes an interface 509 that includes transceiver circuitry to transmit and receive signals to/from the bus 510. In some implementations, the interface 509 is compatible with a CAN-based protocol (e.g., CAN 2.0, CAN FD, or CAN XL). In other implementations, the interface 509 is an Ethernet-compatible interface connected to an Ethernet bus 510.

While the concepts of the present disclosure are susceptible to various modifications and alternative forms, specific examples thereof have been shown in the drawings and are described herein in detail. However, the concepts of the present disclosure are not limited to the particular forms disclosed, but on the contrary, all modifications, equivalents, and alternatives consistent with the present disclosure and the appended claims are also covered.

In the drawings, while some structural or method features may be shown in specific arrangements or orderings, such specific arrangements or orderings may be optional. In some examples, such features may be arranged in a different manner or order than shown in the drawings. Additionally, the inclusion of a structural or method feature in a particular drawing is not meant to imply that such feature is present in all examples and, in some examples, such feature may not be included or may be combined with other features. Further, the various examples shown in the drawings are illustrative representations and may not be drawn to scale. In some instances, the same or similar reference numerals may be used to designate the same or similar features in different drawings.

The disclosed examples may be implemented, in some cases, in hardware, firmware, software, or any combination thereof. The disclosed examples may also be implemented as instructions carried by or stored on one or more transitory or non-transitory machine-readable (e.g., computer-readable) storage media, which may be read and executed by processing circuitry (e.g., on one or more processors). A machine-readable storage medium may be embodied as any storage device, mechanism, or other physical structure for storing or transmitting information in a form readable by a machine, including volatile or non-volatile memory (e.g., random access memory (RAM), flash memory), hard drives (e.g., hard disk drive (HDD), solid state drive (SSD)), media discs, or combinations thereof.

While a number of examples have been disclosed, the following are additional examples that include aspects of the present disclosure. The examples are indicated in various combinations; however, other combinations of examples may be contemplated by the present disclosure.

Example 1 is an apparatus comprising: memory storing a plurality of lookup tables; and processing to: calculate calibrated brightness values for light emitting diodes (LEDs), each calibrated brightness value based on a value indicating a desired brightness, a temperature value, and an age value; store the calibrated brightness values in the lookup tables; receive input brightness signals for a plurality of LEDs; and determine, based on the lookup tables, output brightness signals corresponding to the input brightness signals.

Example 2 includes the apparatus of Example 1, wherein the processing is further to re-calculate the calibrated brightness values after a particular amount of time, wherein the re-calculation is based on new age values or new temperature values.

Example 3 includes the apparatus of Example 1 or 2, wherein each lookup table comprises a plurality of calibrated brightness values for an LED corresponding to respective input brightness values for the LED.

Example 4 includes the apparatus of Example 3, wherein each lookup table stored in the memory corresponds to a particular age value and a particular temperature value.

Example 5 includes the apparatus of Example 3 or 4, wherein each lookup table stored in the memory corresponds to a same age value.

Example 6 includes the apparatus of any one of Examples 1-5, wherein the processing is further to associate each LED of the plurality of LEDs with a particular lookup table of the plurality of lookup tables.

Example 7 includes the apparatus of Example 6, wherein each LED of the plurality of LEDs is associated with a particular lookup table based on a current temperature of the LED.

Example 8 includes the apparatus of any one of Examples 1-7, wherein the processing is to: calculate first calibrated brightness values for red LEDs, second calibrated brightness values for green LEDs, and third calibrated brightness values for blue LEDs; and store the first calibrated brightness values in first lookup tables corresponding to the red LEDs, storing the second calibrated brightness values in second lookup tables corresponding to the green LEDs, and storing the third calibrated brightness values in third lookup tables corresponding to the blue LEDs.

Example 9 includes the apparatus of any one of Examples 1-8, wherein the calibrated brightness values stored in the lookup tables are 8 bit, 12 bit, or 16 bit values.

Example 10 includes the apparatus of any one of Examples 1-9, further comprising circuitry to generate pulse width modulation (PWM) signals based on the calibrated brightness signals.

Example 11 includes the apparatus of any one of Examples 1-10, further comprising an LED array module comprising the plurality of LEDs.

Example 12 includes the apparatus of any one of Examples 1-11, further comprising an input interface to receive the input brightness signals.

Example 13 includes the apparatus of Example 12, wherein the input interface is compatible with a Controller Area Network (CAN)-based bus or Ethernet-based bus.

Example 14 is a method comprising: calculating a plurality of calibrated brightness values for a light emitting diode (LED), each calibrated brightness value based on a desired brightness of the LED, a temperature of the LED, and an age of the LED; storing the calibrated brightness values in lookup tables; receiving input signals indicating a desired brightness for a plurality of LEDs; and determining, using the lookup tables, output signals for the plurality of LEDs based on the input signals.

Example 15 includes the method of Example 14, further comprising re-calculating the calibrated brightness values after a particular amount of time, wherein the re-calculating is based on new age values or new temperature values.

Example 16 includes the method of Example 14 or 15, wherein storing the calibrated values comprises storing, in each lookup table, calibrated brightness values for a particular age and a particular temperature, each calibrated brightness value corresponding to a desired brightness value in the lookup table.

Example 17 includes the method of any one of Examples 14-16, further comprising associating each LED of the plurality of LEDs with a particular lookup table based on a temperature of the LED.

Example 18 includes the method of any one of Examples 14-17, wherein: calculating the plurality of calibrated brightness values comprises calculating first calibrated brightness values for red LEDs, second calibrated brightness values for green LEDs, and third calibrated brightness values for blue LEDs; and storing the calibrated brightness values comprises storing the first calibrated brightness values in first lookup tables corresponding to the red LEDs, storing the second calibrated brightness values in second lookup tables corresponding to the green LEDs, and storing the third calibrated brightness values in third lookup tables corresponding to the blue LEDs.

Example 19 includes the method of any one of Examples 14-18, wherein the calibrated brightness values are 8 bit, 12 bit, or 16 bit values.

Example 20 includes the method of any one of Examples 14-19, further comprising generating pulse width modulation (PWM) signals based on the output signals.

Example 21. One or more non-transitory machine-readable storage media having instructions stored thereon, wherein the instructions, when executed by processing circuitry, cause the processing circuitry to: calculate a plurality of calibrated brightness values, each calibrated brightness value based on a desired brightness value, a temperature value, and an age value; store the calibrated brightness values in lookup tables; and determine, using the lookup tables, output signals for a plurality of LEDs based on input signals indicating desired brightness values for the plurality of LEDs.

Example 22 includes the non-transitory machine-readable storage media of Example 21, wherein the instructions are further to re-calculate the calibrated brightness values after a particular amount of time, wherein the re-calculating is based on new age values or new temperature values.

Example 23 includes the non-transitory machine-readable storage media of Example 21 or 22, wherein each respective lookup table comprises calibrated brightness values for a given age and a given temperature, each calibrated brightness value of the lookup table corresponding to an input brightness value.

Example 24 includes the non-transitory machine-readable storage media of any one of Examples 21-23, wherein the instructions are further to associate each LED of the plurality of LEDs with a particular lookup table based on a temperature of the LED.

Example 25 includes the non-transitory machine-readable storage media of any one of Examples 21-24, wherein the instructions are to: calculate first calibrated brightness values for red LEDs, second calibrated brightness values for green LEDs, and third calibrated brightness values for blue LEDs; and store the first calibrated brightness values in first lookup tables corresponding to the red LEDs, storing the second calibrated brightness values in second lookup tables corresponding to the green LEDs, and storing the third calibrated brightness values in third lookup tables corresponding to the blue LEDs.

Example 26 includes the non-transitory machine-readable storage media of any one of Examples 21-25, wherein the calibrated brightness values are 8 bit, 12 bit, or 16 bit values.

Example 27 includes the non-transitory machine-readable storage media of any one of Examples 21-26, wherein the instructions are further to generate pulse width modulation (PWM) signals based on the determined output signals.

Example 28 is a device comprising: an array of light emitting diodes (LEDs); driver circuitry for the LEDs; memory storing a plurality of lookup tables, each lookup table comprising a plurality of calibrated brightness values for an LED corresponding to respective input brightness values for the LED; an input interface; and processing circuitry to: calculate the calibrated brightness values, each calibrated brightness value calculated based on an input brightness value, a temperature value, and an age value; store the calibrated brightness values in the lookup tables; receive, from the input interface, input brightness signals for the LEDs; determine, based on the lookup tables, output brightness signals for the LEDs based on the input brightness signals.

Example 29 includes the device of Example 28, wherein the processing circuitry is further to re-calculate the calibrated brightness values after a particular amount of time, wherein the re-calculating is based on new age values or new temperature values.

Example 30 includes the device of Example 28 or 29, wherein each respective lookup table comprises calibrated brightness values for a given age and a given temperature, each calibrated brightness value of the lookup table corresponding to an input brightness value.

Example 31 includes the device of any one of Examples 28-30, wherein the processing circuitry is further to associate each LED with a particular lookup table based on a temperature of the LED.

Example 32 includes the device of any one of Examples 28-31, wherein the input interface is compatible with a Controller Area Network (CAN)-based bus or Ethernet-based bus.

Example 33 includes the device of any one of Examples 28-32, wherein the processing circuitry comprises an application-specific integrated circuit (ASIC).

Example 34 includes the device of any one of Examples 28-33, wherein the array of LEDs comprises red LEDs, blue LEDs, and green LEDs, the driver circuitry comprises respective driver circuitries for the red LEDs, the blue LEDs, and the green LEDs, and the processing circuitry is further to: calculate first calibrated brightness values for red LEDs, second calibrated brightness values for green LEDs, and third calibrated brightness values for blue LEDs; and store the first calibrated brightness values in first lookup tables corresponding to the red LEDs, storing the second calibrated brightness values in second lookup tables corresponding to the green LEDs, and storing the third calibrated brightness values in third lookup tables corresponding to the blue LEDs.

1. An apparatus comprising:
memory storing a plurality of lookup tables; and
processing circuitry to:
calculate calibrated brightness values for light emitting diodes (LEDs), each calibrated brightness value based on a value indicating a desired brightness, a temperature value, and an age value;
store the calibrated brightness values in the lookup tables;
receive input brightness signals for a plurality of LEDs; and
determine, based on the lookup tables, output brightness signals corresponding to the input brightness signals.

2. The apparatus of claim 1, wherein the processing is further to re-calculate the calibrated brightness values after a particular amount of time, wherein the re-calculation is based on new age values or new temperature values.

3. The apparatus of claim 1, wherein each lookup table comprises a plurality of calibrated brightness values for an LED corresponding to respective input brightness values for the LED.

4. The apparatus of claim 3, wherein each lookup table stored in the memory corresponds to a particular age value and a particular temperature value.

5. The apparatus of claim 3, wherein each lookup table stored in the memory corresponds to a same age value.

6. The apparatus of claim 1, wherein the processing is further to associate each LED of the plurality of LEDs with a particular lookup table of the plurality of lookup tables.

7. The apparatus of claim 6, wherein each LED of the plurality of LEDs is associated with a particular lookup table based on a current temperature of the LED.

8. The apparatus of claim 1, wherein the processing is to:
calculate first calibrated brightness values for red LEDs, second calibrated brightness values for green LEDs, and third calibrated brightness values for blue LEDs; and
store the first calibrated brightness values in first lookup tables corresponding to the red LEDs, storing the second calibrated brightness values in second lookup tables corresponding to the green LEDs, and storing the third calibrated brightness values in third lookup tables corresponding to the blue LEDs.

9. The apparatus of claim 1, wherein the calibrated brightness values stored in the lookup tables are 8 bit, 12 bit, or 16 bit values.

10. The apparatus of claim 1, further comprising circuitry to generate pulse width modulation (PWM) signals based on the calibrated brightness signals.

11. The apparatus of claim 1, further comprising an LED array module comprising the plurality of LEDs.

12. The apparatus of claim 1, further comprising an input interface to receive the input brightness signals, the input interface compatible with a Controller Area Network (CAN)-based bus or Ethernet-based bus.

13. A method comprising:
calculating a plurality of calibrated brightness values for a light emitting diode (LED), each calibrated brightness value based on a desired brightness of the LED, a temperature of the LED, and an age of the LED;
storing the calibrated brightness values in lookup tables;
receiving input signals indicating a desired brightness for a plurality of LEDs; and
determining, using the lookup tables, output signals for the plurality of LEDs based on the input signals.

14. The method of claim 13, further comprising re-calculating the calibrated brightness values after a particular amount of time, wherein the re-calculating is based on new age values or new temperature values.

15. The method of claim 13, wherein storing the calibrated values comprises storing, in each lookup table, calibrated brightness values for a particular age and a particular temperature, each calibrated brightness value corresponding to a desired brightness value in the lookup table.

16. The method of claim 13, further comprising associating each LED of the plurality of LEDs with a particular lookup table based on a temperature of the LED.

17. A device comprising:
an array of light emitting diodes (LEDs);
driver circuitry for the LEDs;
memory storing a plurality of lookup tables, each lookup table comprising a plurality of calibrated brightness values for an LED corresponding to respective input brightness values for the LED;
an input interface; and
processing circuitry to:
calculate the calibrated brightness values, each calibrated brightness value calculated based on an input brightness value, a temperature value, and an age value;
store the calibrated brightness values in the lookup tables;
receive, from the input interface, input brightness signals for the LEDs;
determine, based on the lookup tables, output brightness signals for the LEDs based on the input brightness signals.

18. The device of claim 17, wherein the processing circuitry is further to re-calculate the calibrated brightness values after a particular amount of time, wherein the re-calculating is based on new age values or new temperature values.

19. The device of claim 17, wherein the array of LEDs comprises red LEDs, blue LEDs, and green LEDs, the driver circuitry comprises respective driver circuitries for the red LEDs, the blue LEDs, and the green LEDs, and the processing circuitry is further to:
calculate first calibrated brightness values for red LEDs, second calibrated brightness values for green LEDs, and third calibrated brightness values for blue LEDs; and
store the first calibrated brightness values in first lookup tables corresponding to the red LEDs, storing the second calibrated brightness values in second lookup tables corresponding to the green LEDs, and storing the third calibrated brightness values in third lookup tables corresponding to the blue LEDs.

20. The device of claim 17, wherein the processing circuitry comprises an application-specific integrated circuit (ASIC) and the input interface is compatible with a Controller Area Network (CAN)-based bus or Ethernet-based bus.
